(19) United States
(12) Patent Application Publication
(10) Pub. No.: US 2006/0101520 A1
(43) Pub. Date: May 11, 2006

(54) Method to manage network security over a distributed network

(76) Inventors: Troy T. Schumaker, Pine, CO (US); Demetrios Lazarikos, Denver, CO (US)

Correspondence Address: Mark A. Thomas, P.C., 10138 South Cottoncreek Drive, Highlands Ranch, CO, 80130-3848, US

(21) Appl. No.: 11/268,992

(22) Filed: Nov. 7, 2005

Related U.S. Application Data
(60) Provisional application No. 60/625,682, filed on Nov. 5, 2004.
(60) Provisional application No. 60/625,678, filed on Nov. 5, 2004.
(60) Provisional application No. 60/625,679, filed on Nov. 5, 2004.

(51) Int. Cl. G06F 11/00

(52) U.S. Cl. 726/25

(57) ABSTRACT

The present invention provides a system with a first controller device that exercises control over one or more secondary controller devices and one or more remote testing devices. The remote testing devices accomplish all scanning of the distributed networks but remain under the control and management of the controller device. To complete a vulnerability assessment of the entire distributed network, the controller device schedules scans for each of the remote testing devices. The remote testing devices scan the network to which they are attached. Each remote testing device reports the results of the several scans to the controller device. The controller device also manages regulatory compliance information for the system. The controller device may consolidate the results to create an organization-wide vulnerability and compliance database.

### CROSS REFERENCES TO RELATED APPLICATIONS

This patent application claims the benefit of provisional U.S. Patent Application Ser. No. 60/625,682, filed Nov. 5^{th}, 2004, provisional U.S. Patent Application Ser. No. 60/625,678, filed Nov. 5^{th}, 2004 and provisional U.S. Patent Application Ser. No. 60/625,679, filed Nov. 5^{th}, 2004, all of which are hereby incorporated by reference in their entireties.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The invention relates generally to computer security and the detection, management, and resolution of computer vulnerabilities. In particular, the invention relates to the management of several testing systems positioned in remote networks and managed by a single device in which a consolidated collection of vulnerabilities for a distributed network can be managed and resolved with the single device.

2. Description of the Related Art

Computer networks have created an interconnected world wherein computers can be accessed from anywhere through a public network connection. This interconnectedness has, along with its advantages, created an environment where computers may be attacked or accessed by unauthorized entities. Interconnected computers are vulnerable to viruses, denial of service attacks, and many other insidious invasions.

To address these vulnerabilities, vulnerability detection and resolution became a requirement for any organization with a computer network attached to a public network. Security consulting firms filled the market with a labor intensive approach to discovering and resolving network security vulnerabilities. More recently, some of the discovery functions have become automated, providing security personnel with the ability to find vulnerabilities in the local network. Tools were developed to help remediate the vulnerabilities

Large organizations created and connected to remote networks as their offices spread worldwide. These separate networks could be connected through internet communications in a configuration known as a distributed network. Yet, each network had its own security issues. Unlike the other functions of the businesses, there was no central control or management of the vulnerabilities. Thus, in distributed networks, each individual office had to discover and address its own vulnerabilities.

U.S. patent application 0,217,039 A1 to Kurtz attempts to solve this problem. The patent provides a single network security system that can test remote networks. Thus, a single security system at the headquarters may scan for vulnerabilities and manage those vulnerabilities. Unfortunately, the system creates a new set of problems. Remote sites have no means of testing their networks separately from the single system at the headquarters. Only one remote network may be tested at one time without the use of threads. Remote facilities may not have access to the remediation information because it is stored at another location with the single security system. Furthermore, many organizations have hierarchical structures such as a headquarters and subordinate organizations that run in a decentralized manner, where subordinates may run their operations in a manner that is highly autonomous from the headquarters. [0005] In summary, a need still exists to provide an advanced computer vulnerability remediation system that can help distributed networks manage their security vulnerabilities, address the complexities of managing the vulnerability data associated with decentralized, hierarchical organizations, and help organizations comply with multiple, often overlapping regulatory requirements.

### SUMMARY OF THE INVENTION

The present invention provides a system and method to overcome the problems in the prior art. A first controller device, referred to as an enterprise server (a “master” enterprise server or “Master” in a hierarchical deployment), exercises control over one or more other enterprise servers (subordinate enterprise servers or “Subordinates” in a hierarchical deployment) or one or more remote testing devices. The remote testing devices accomplish all scanning of the distributed networks but remain under the control and management of their assigned enterprise server (either Master or Subordinate).

Gathering required information for an accurate assessment of an organization's compliance posture and vulnerabilities requires both automated components and questionnaires. To complete an automated vulnerability assessment of the entire distributed network, an enterprise server schedules scans for each of the remote testing devices. The remote testing devices scan the network to which they are attached. Each remote testing device reports the results of the several scans to an enterprise server. That enterprise server may consolidate the results to create an organization-wide vulnerability database, or in the case of a hierarchical deployment, the Subordinates will report their results to the Master to create the organization-wide database.

Remediation of the vulnerabilities and compliance to regulations includes the assignment of the responsibility for resolving the vulnerabilities and issues to one or more people or entities. Assignments may be created by accessing the vulnerability database in an enterprise server and manually or using rule-based, event-driven, automatic assignment of vulnerabilities and issues to responsible parties via an appropriate electronic means in a work flow based, business process management system. After resolution, the enterprise server may schedule additional testing at a remote testing device to verify the fix. The vulnerability database shows the issue as accomplished once the verification is completed. Further, an organization can then accurately view its compliance posture against relevant regulations and security standards or frameworks.

### BRIEF DESCRIPTION OF THE DRAWINGS

FIG. 1 shows an embodiment of a system to discover and remediate computer network vulnerabilities in a distributed network system according to the present invention.

FIG. 2 shows an embodiment of an enterprise server according to the embodiments of the present invention.

FIG. 3 shows an embodiment of a remote testing device according the present invention.

FIG. 4 shows an embodiment of a colocation information system to distribute and receive vulnerability information among a plurality of enterprise servers according to the present invention.

FIG. 5 shows an embodiment of a method to scan for vulnerabilities on a distributed network system according to the present invention.

FIG. 6 shows an embodiment of a method to remediate vulnerabilities on a distributed network system according to the present invention.

FIG. 7 shows an embodiment of a method to create security policies on a distributed network system according to the present invention.

FIG. 8 shows an embodiment of a centralized compliance policy making method in a distributed network environment according to embodiments of the present invention.

FIG. 9 shows an embodiment of a distributed vulnerability and management system to limit access to organizational networks according to the present invention.

FIG. 10A through FIG. 10I shows several embodiments of methods to limit access to organizational networks according to the present invention.

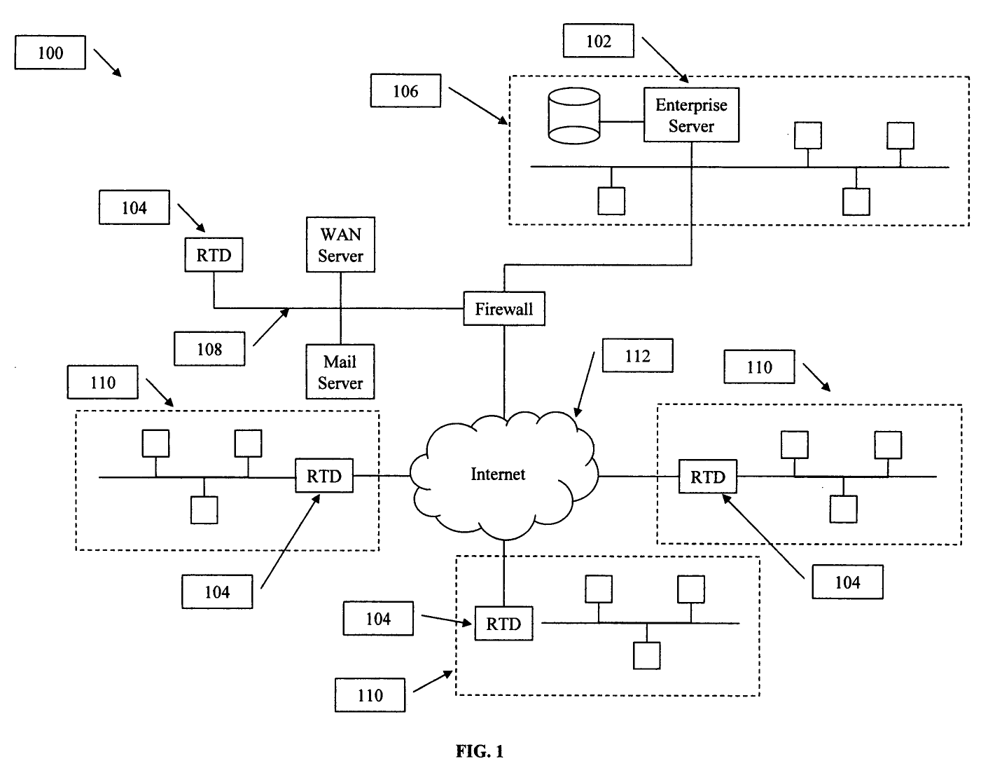

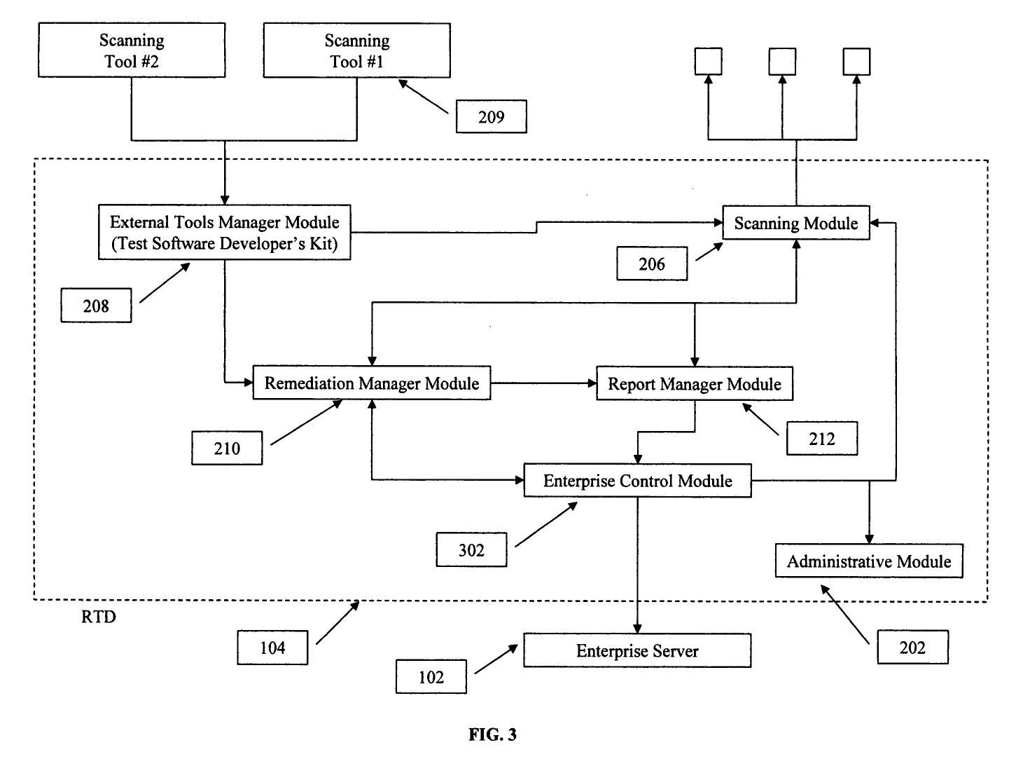

To clarify, each drawing includes reference numerals. These reference numerals follow a common nomenclature. The reference numerals will have three or four digits. The first one or two digits represents the drawing number where the reference numeral was first used. For example, a reference numeral used first in drawing one will have a number like 1XX while a number first used in drawing five will have a number like 5XX. The second two numbers represent a specific item within a drawing. One item in FIG. 1 will be 101 while another item will be 102. Like reference numerals used in later drawing represent the same item. For example, reference numeral 102 in FIG. 3 is the same item as shown in FIG. 1.

### DETAILED DESCRIPTION OF THE INVENTION

This disclosure sets forth specific embodiments and details to provide sufficient understanding of the present invention. However, one skilled in the art will recognize that the invention may be practiced without these specific details or in a form different than the specific embodiments. In addition, some diagrams use block diagrams or general schematics not to overburden the description with unneeded details. It will be noted that the invention may be performed in either hardware, software, or a combination of hardware and software. Certain terms and names are used to refer to particular systems throughout the description and the claims. One skilled in the art will appreciate that particular systems may be referred to by different names or different terms, and this description attempts to distinguish between components by function rather than name. Throughout this description, the term “couple” or “couples” means any type of direct or indirect electrical or communicative connection.

Distributed Vulnerability and Assessment Management System (DVAMS)

The distributed vulnerability and assessment management system (DVAMS) 100 is a web-based architecture as shown in FIG. 1. The DVAMS includes an Enterprise Server 102 coupled to one or more remote testing devices (RTD) 104. The Enterprise Server 102 is a single unit located at a central location 106 or a headquarters location. Each RTD 104 is located on a sub-network 108 or distant network 110 separated by some distance. Each location 110 or sub-network 108 may have one or more RTDs 104. The Enterprise Server 102 may communicate bi-directionally with the RTDs 104 through an Internet connection 112, such as the World Wide Web, or through an intranet, such as a LAN or WAN. Communications are completed in the network protocol of the Internet or intranet used, but preferably, in an https protocol. This distributed vulnerability management model 100 provides remote scanning of several networks 108 or 110 and central control of the complete network vulnerability remediation system 100. Each of the systems will be explained in more detail below.

Enterprise Server 102

The Enterprise Server 102 provides the local network with the same functions as the RTD 104. In addition, the Enterprise Server 102 functions as the central control for all of the RTDs 104. As an example, the Enterprise Server 102 can be a rack mounted server operating a Linux operating system, coded in Java with a file import capability that can accept XML inputs. The server may be running a Pentium processor and have a memory that can include a relational database developed in MySQL. The Enterprise Server 102 may also be a software module installed on a computer connected to the network. In addition, the Enterprise Server 102 may be a self-bootable program stored on a computer readable media that can be run from system memory of an existing computer on the network. The Enterprise Server 102 may also be connected to one or more memories to store information. The memories may include, but are not limited to, RAID systems, RAM, ROM, disk drives, optical storage.

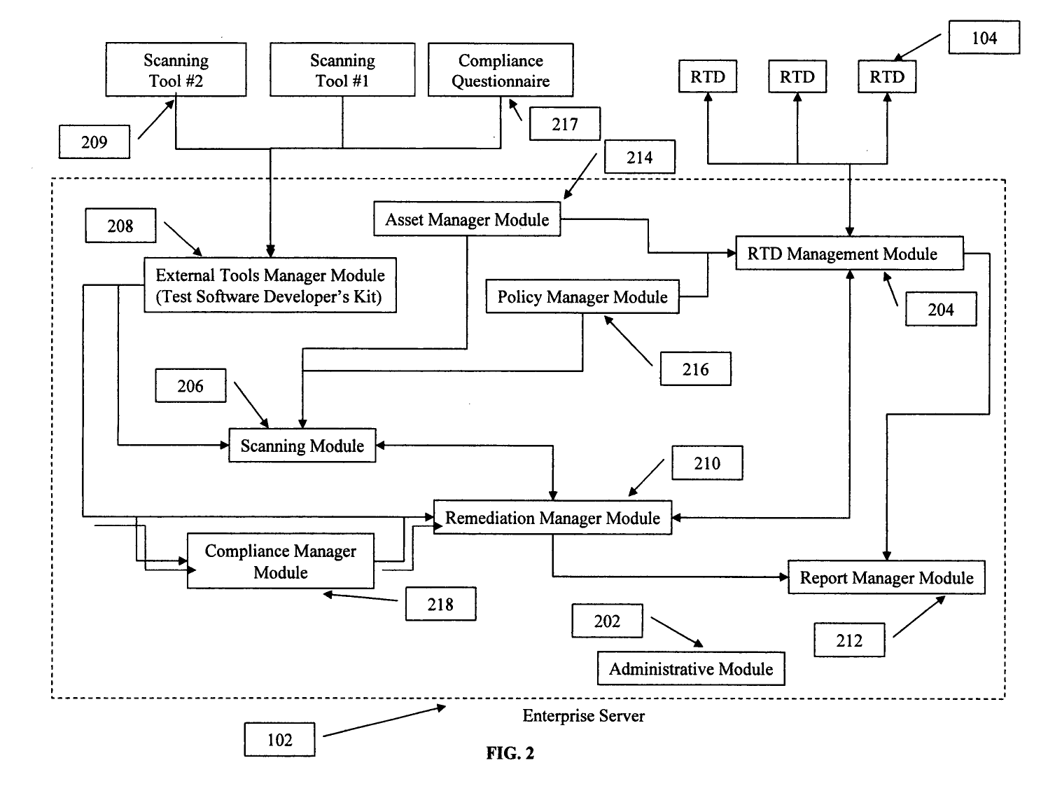

An embodiment of the Enterprise Server 102 is shown in FIG. 2. The Enterprise Server 102 includes a RTD Management Module 204. The Enterprise Server 102 may also include an asset manager module 214, a policy manager module 216, a scanning module 206, a remediation module 210, a report manager module 212, an administrative module 202, a compliance manager module 218 and an external tools manager module (also referred to as the test software developer's kit or TSDK) 208. Each of the modules has certain functions. One or more of the modules may be coupled or connected, sharing information either uni-directionally or bi-directionally. These modules may be integrated into a single computer or distributed among several computers. Each module with its functions and interconnections will be described further hereinafter.

The administrative module 202 controls access to the Enterprise Server 102. This module 202 assigns access privileges to different individuals. An identification code and a password are given to each privileged user to allow them to access the Enterprise Server 102. Privileges may differ from person to person. Some people may have general access to the Enterprise Server 102, while other users may have more limited access. In one embodiment, the administrative module 202 can also control the sharing of vulnerability and compliance data in an organization consisting of multiple Enterprise Servers 102 operating in a hierarchical relationship.

The RTD Management Module 204 controls and interacts with the RTDs 104. The Enterprise Server 102 can determine for the RTDs 104 what tests and scans may be run, when the tests and scans may be run, on what system devices to run the tests and scans, and how to report and manage the vulnerabilities identifies by the tests and scans. More specifically, the RTD management module 204 will connect with the each RTD 104 to establish a time to run a certain scan (or to run that scan immediately). For instance, one RTD 104 may be connected to a network in Europe. The RTD management module 204 can schedule that RTD 104 to run during the evening in Europe. A second RTD 104 may be in California, and the Enterprise Server 102 can schedule that RTD 104 to run the same scan during the evening in California. Thus, the RTDs 104 may run the same scans at different times in different places and be managed by the same RTD management module 204.

Once a scan is run by an RTD 104, the RTD 104 may report several items of information to the RTD management module 204 including, but not limited to, what systems are attached to the network at the remote location, what vulnerabilities exist, who uses the systems, what operating systems or software are run on the systems, or what are the characteristics of the systems. The RTD management module 204 may forward this information to other systems for further use. In return, the RTD management module 204 may send further information back to the Enterprise Server 102. For instance, the RTD management module 204 can send vulnerability updates to the RTD 104 for use in improved scanning, security policies to which the RTD 104 should scan for compliance, changes to the asset management policies at the remote location, assignments for resolving discovered vulnerabilities, or information on how to resolve discovered vulnerabilities. Some of these processes will be explained later. The remaining processes will be understood by one skilled in the art.

The scanning module 206 scans for many different aspects that affect computer security. These scans can include, but are not limited to, scans for open ports, unauthorized network services, viruses, or Trojan horses. Custom designed scanning software may be employed by the scanning module 206. However, the scanning module 206 may also employ one or more currently existing scanners including, but not limited to, ISS Internet Scanner, Newt, Nessus, Eeye, Harris, Retina, Microsoft's hfNetCheck, or others. It is immaterial what types of scanners are used in the scanning module 206.

In still another embodiment, scanning tools 209 or compliance questionnaires 217, automated or otherwise, may exist outside the Enterprise Server 102. For instance, the network security personnel may already employ scanning tool #1 and tool #2 209. Or, an automated or manual compliance questionnaire 217 may be used to gather information about an organization's compliance posture. An external tool manager module or TSDK 208 may provide an interface for these outside scanning tools 209 and compliance questionnaire tools 217. The TSDK 208 can use, for example, an API interface to import XML output from the tools into the Enterprise Server 102. The TDSK 208 can manipulate the data to conform to the internal protocols of the scanning module 206, the compliance manager module 218 and the remediation module 210.

Compliance questionnaire tools 217 help an organization assess its posture against compliance requirements. These tools may be manual or automated in nature and created by a 3^{rd} party or, in an exemplary embodiment, by the compliance manager module 218, with a capability to upload to the TDSK 208.

A compliance manager module 218 helps the organization manage its compliance posture. The operating environment for information technology (IT) is increasingly controlled by the compliance requirements of government entities, self-regulating organizations, and vendor-based regulations, where compliance is measured against published IT frameworks (such as COBIT and ISO 17799) and regulatory standards (such as Sarbanes-Oxley and the payment card industry's PCI Data Security Standard). In IT environments of large organizations, gathering critical information relative to an organization's compliance posture against multiple regulatory requirements and the resulting remediation of large quantities information security vulnerabilities and compliance related issues can be overwhelming for relatively limited staff, and there is a need to further automate the data gathering and remediation processes beyond the current art. The compliance manager 218 can store compliance standards and security frameworks, and may be designed to allow organizations to create customized security frameworks. For example, an organization may be subject to compliance requirements of Sarbanes-Oxley and the PCI Data Security requirements. That organization may want to create a proprietary security framework that combines elements of COBIT with non-overlapping elements of the PCI Data Security requirements, resulting in the creation of a security framework that is proprietary to that organization. The compliance manager 218 may accept input directly by an authorized user or from automated or manual questionnaire input 217 via the TDSK 208. It will process this information and questionnaire input against its selected frameworks and compliance requirements, and create input to the database and to the remediation manager module 210. This processing can include cross-correlation of scan results and compliance issues, and statistical and differential analysis of received results against compliance requirements, security frameworks, and historical data. In an exemplary embodiment, compliance questionnaires 217 may be automatically generated as a function of the compliance manager module 218 and customized to an organization. A user may answer a series of questions regarding the organization's compliance environment via an interface to the compliance manager module 218. The compliance manager module 218 may generate a unique set of automated questions for that user that are designed to gather response information to help determine the organization's compliance posture against the selected parameters and which are relevant to the organization's actual compliance environment. The resulting compliance questionnaire 217 may be designed to work in a stand alone mode, with store and forward capabilities to the TDSK 208. In another embodiment, the compliance questionnaire 217 may be designed to operate via an Internet or intranet connection to the compliance manager module 218.

A remediation manager module 210 helps the organization ameliorate discovered vulnerabilities and compliance issues from the compliance manager module 218. For large organizations with a significant quantity of computing devices and compliance requirements, these vulnerabilities and compliance issues may number in the thousands, with only a limited staff available to address them. The remediation manager 210 may organize the vulnerabilities and compliance issues into a database. The database may include, but is not limited to, the vulnerability or compliance issue, a ranking of same according to the possible damage it may produce or the likelihood of occurrence, a list of the devices affected and where the devices are located, a description of the vulnerability or issue, who was assigned to resolve it, and a method of resolving it. The remediation manager 210 allows the vulnerabilities and issues to be assigned to an IT administrator or computer security personnel for resolution. The remediation database can track when the vulnerability or issue was found, when it was resolved, and whether the resolution was verified. The remediation manager module 210 aids in all the informational requirements for resolution of the vulnerabilities and compliance issues. In an exemplary embodiment, the remediation manager module 210 may include the capability for creating a unique rule set as to how certain types of vulnerability and remediation issues should be assigned or processed, and may include event-driven actions based on a customized rule set that maximize the efficiency and effectiveness of remediation resources. This may be accomplished by the remediation module 210 by analyzing the skills and availability of resources and automatically correlating and assigning the best resource to resolve the vulnerability or compliance issue.

The report manager module 212 provides detailed or summary information about the vulnerabilities, compliance issues and the remediation efforts. Some of the information the report manager module 212 may provide includes, but is not limited to, the number of vulnerabilities and issues, the risk rating, where the vulnerabilities and compliance issues are, whether they have been assigned, to whom they have been assigned, whether they have been fixed, when the fix was done, whether the fix was verified, and who fixed the vulnerability or compliance issue.

The asset manager module 214 can create and store a file that documents the networks attached devices for both the local network and all distant networks. This file may be referred to as the Client Master File (CMF). The CMF may also include, but is not limited to, lists of operating systems, peripherals, software stored on devices, or other information. The CMF may be populated by the scanning module, by importing the information, or by hand entry. The asset manager module 214 may provide information to the scanning module for what needs to be scanned.

A policy manager module 216 allows a system administrator or other personnel to create organization-wide security policies. These security policies may include, but are not limited to, allowable or disallowable programs, restrictions on certain computers or computer users, allowed systems or peripherals, and other security rules. The policy manager 216 can provide information to the scanning module 206 to narrow or broaden the focus of the tests run. In addition, the policy manager 216 may send the security policy to the RTD management module 204 for distribution to the remote RTDs 104. Thus, consistent security policies can be adopted and disseminated throughout the organization.

Remote Testing Devices

The RTDs 104 provide the vulnerability scanning function of the distributed networks. An embodiment of the RTD is shown in FIG. 3. An RTD 104 monitors a network block or a range of IP addresses. In addition, the RTDs 104 may report the scanning results to the Enterprise Server 102 or receive updated vulnerability information from the Enterprise Server 102. The Enterprise Server 102 may function as a vulnerability scanner for the network to which it is attached.

In some embodiments, the RTD 104 is a hardware appliance connected to the network it monitors. In an exemplary embodiment, the RTD 104 is a 1U rack mount server running a Pentium Processor that operates a Linux operating system. An RTD 104 may also be software stored in memory on a computer connected to the monitored network. A unique embodiment employs the RTD 104 as a software function recorded on a computer readable media, such as a compact disc (CD). The CD may be a self-bootable program that does not reside in permanent storage but runs from memory, such as RAM or ROM, during its operation. After finishing the monitoring functions, the program is aborted, and the program is erased from the memory. Thus, the remote sites may not need to install any hardware or software but can use the CD to perform all the testing functions.

The RTD 104 includes a scanning module 206 and an enterprise control module 302. In addition, the RTD 104 may include an external tools manager module 208, a remediation manager module 210, a report manager module 212, and an administrative module 202. The scanning module 206, external tools manager module 208, remediation manager module 210, report manager module 212, and the administrative module 202 may function similarly to the similarly named modules in the Enterprise Server 102. The enterprise control module 302 receives the commands and control commands from and sends information to the RTD management module 204. In turn, the enterprise control module 302 communicates with the other various modules to give effect to the Enterprise Server 102 commands.

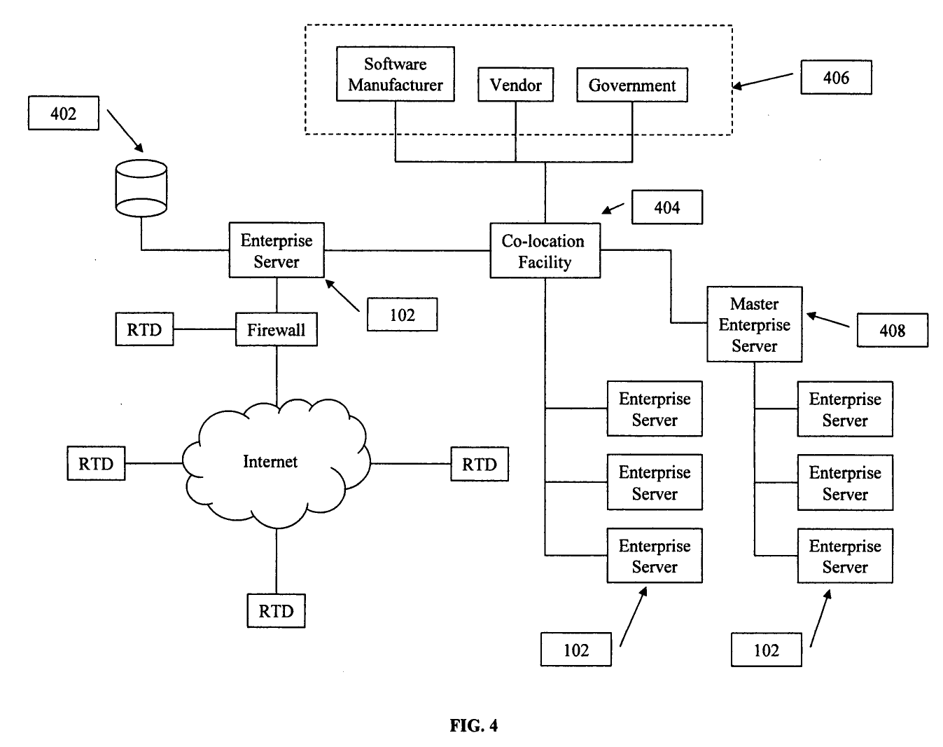

FIG. 4 shows different embodiments in which a plurality of Enterprise Servers 102 may manage the computer security vulnerabilities and compliance posture for a plurality of corresponding organizations. In one embodiment, the plurality of Enterprise Servers 102 may be coupled to a colocation facility 404. The colocation facility 404 may have access to each CMF 402 from each Enterprise Server 102. The CMF 402 may be used by the colocation facility 404 to contact vendors, manufacturers, government organizations, or other entities 406 to receive updated information on vulnerabilities and compliance issues. These updates may be disseminated to the Enterprise Servers 102. In one embodiment, the dissemination may be customized according to the contents of the CMF 402 file. Therefore, each Enterprise Server 102 receives updates specific to the hardware and software resident on that organization's networks. In another embodiment representing a hierarchically operating organization, a plurality of subordinate Enterprise Servers 102 may also be coupled to a “Master” Enterprise Server 408 such that information concerning vulnerabilities and compliance issues are shared between a subordinate Enterprise Server 102 and the Master Enterprise Server 408. This allows the master Enterprise Server 408 to consolidate the vulnerability and compliance posture for the entire organization, and manage the consolidated results, information, and activities across the entire organization's network.

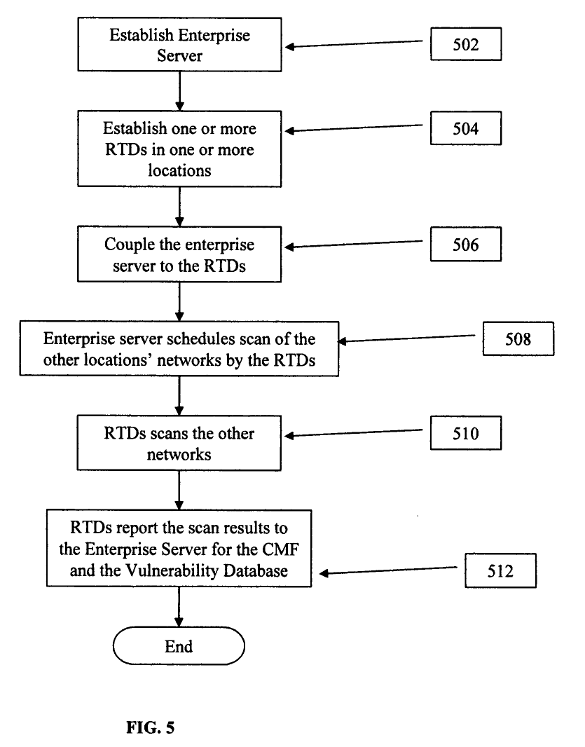

FIG. 5 shows an embodiment of a method for distributed scanning. An Enterprise Server 102 is established 502 in a first location. Establishing the Enterprise Server 102 may involve installing the 1U device in a network or uploading a software program onto an existing server or computer. One or more RTDs 104 are established 504 in other locations. Again, the RTDs 104 may be a hardware device or a software program. The RTDs 104 are coupled 506 to the Enterprise Server 102. In other words, communications are established between the RTDs 104 and the Enterprise Server 102 through an Internet or an intranet link. The Enterprise Server 102 then assumes control over the RTD 104. The Enterprise Server 102 can then schedule 508 a scan on the organization's networks. This scan may occur immediately or may occur at some time in the future. Regardless, the Enterprise Server 102 can scan the local network attached to the Enterprise Server 102 while the one or more RTDs 104 will scan 510 the networks in the other locations. The RTDs 104 report the results 512 of the scan back to the Enterprise Server 102. The Enterprise Server 102 consolidates the results from the one or more RTDs 104 with the results from the scan of the local network. This consolidated information may form the basis of the vulnerability and compliance database and the CMF.

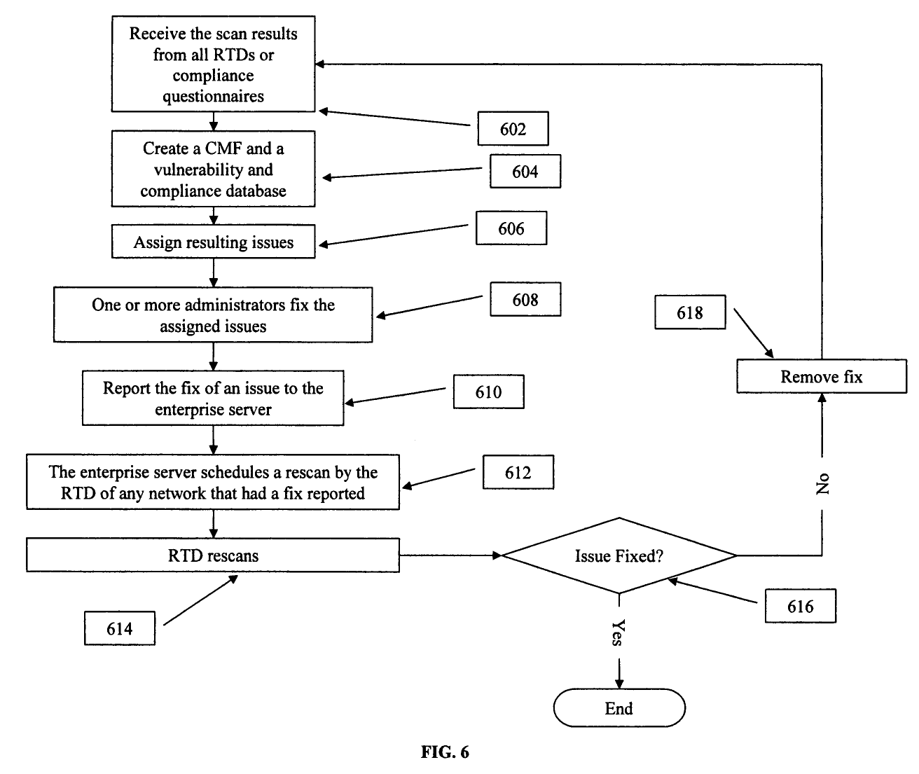

FIG. 6 shows an embodiment of distributed remediation of network vulnerabilities and compliance issues. The results from the scans of the local and remote networks and compliance questionnaires are received 602 by the Enterprise Server 102. The CMF is created 604 recording the characteristics of the network and its devices. A vulnerability and compliance database may also be created 604 that stores information about the vulnerabilities and compliance issues discovered. A manager or other IT security person may access the vulnerability and compliance database. Once accessed, the manager may assign 606 the resolution of the known vulnerabilities and compliance issues to people, groups, subordinates, subsidiaries, or other entities. These assignments may be distributed through the enterprise engine to the RTDs 104 or by other organizational communication channels. An entity may resolve 608 or attempt to resolve the vulnerability or compliance issue. Once resolved, the entity may report 610 the fix to the Enterprise Server 102. This reporting may be done through the RTD 104 back to the Enterprise Server 102 or by other communication channel.

The vulnerability and compliance database may be updated showing that the issue was resolved. However, in an exemplary embodiment, the Enterprise Server 102 may schedule 612 a new scan by the RTD 104 to verify the fix. The Enterprise Server 102 sends a new scan command to the RTD 104 either specifying a particular test for the resolved vulnerability or a general test that will also encompass testing of the resolved vulnerability. The RTD 104 rescans 614 the network or device according to the Enterprise Server 102 commands. If the vulnerability is fixed 616, then the vulnerability will be reported as fixed to the enterprise server and, in the database, will be modified accordingly. However, if the vulnerability remains 616, the fix may be removed 618 or may remain. In either case, the new scan results are used to update the database and the process occurs again.

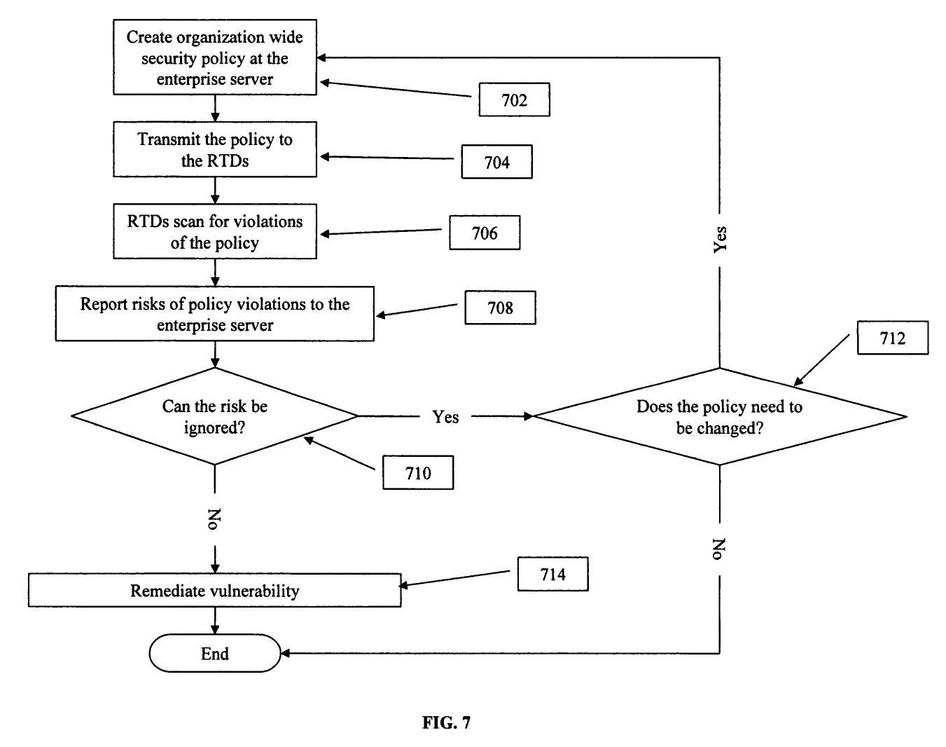

FIG. 7 shows an embodiment of a centralized security policy making method in a distributed network environment. A manager or IT security person establishes 702 a security policy on the Enterprise Server 102. For instance, the security policy may disallow Instant Messenger on any computer. This security policy may be transmitted 704 by the Enterprise Server 102 to one or more remote RTDs 104. The RTDs 104 may incorporate the security policy into the list of items to be scanned by the RTD 104. The RTD 104 may scan 706 for violations of the security policy either immediately or during the next scheduled scan. If someone or something has violated the policy, for instance, has IM installed on their computer, that violation may create a risk message. This risk message may be transmitted 708 by the RTD 104 to the Enterprise Server 102. In one embodiment, the security personnel at the Enterprise Server 102 may review the risk and determine 710 if the risk can be ignored. For instance, the Vice President of European Operations created the risk because she uses IM in her daily communications. The security personnel, not wishing to interrupt the Vice President's work may ignore the risk. If the risk is ignored, the security personnel may wish to change 712 the security policy. If the security policy needs to be changed, for instance, eliminating the IM ban for executive officers, then the security policy can be modified or recreated 702, and the process will begin again. If no change is needed and the risk is simply accepted, the process ends. However, if the risk cannot be ignored, the risk may become 714 a vulnerability that the system should remediate in the remediation process.

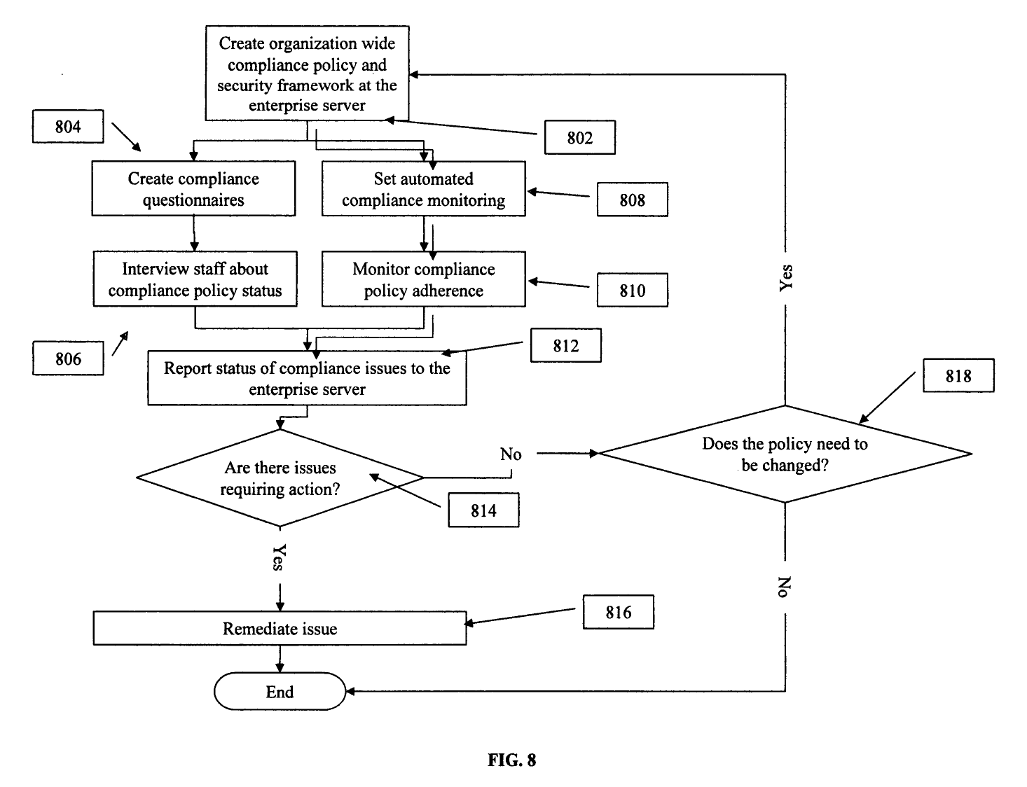

FIG. 8 shows an embodiment of a centralized compliance policy making method in a distributed network environment. A manager or IT security person establishes 802 the compliance policy and security framework for the organization on the Enterprise Server 102. For instance, the organization might be subject to Sarbanes-Oxley regulations and Visa's PCI security standard. The organization may decide to meet these compliance requirements by using the COBIT security framework and select additional options to also accommodate the PCI security requirements. The organization may determine it should use the compliance manager module 218 to create automated questionnaires 804 for use in collecting information about the organization's compliance status against these requirements. The automated questionnaires 804 may incorporate the compliance policy requirements into the list of items to be asked by the automated questionnaire 804. The automated questionnaire 804 will collect data about compliance policy status during interviews with the organization's staff 806, and report the status of compliance policy issues 812 to the Enterprise Server 102 via an upload through the TDSK 208. As the manager or IT security person establishes the compliance policy and security framework 802, the compliance manager module 218 will automatically set policy violation detection capabilities 808 in the Enterprise Server 102. For example, under Visa's PCI Security Standard, there is a requirement for quarterly scans of devices that are Internet accessible. If a quarterly scan is not performed, the compliance manager module 218 may automatically detect the violation of compliance policy 810, and notify the Enterprise Server 102. Security personnel may review the organization's compliance status of compliance to determine if an action needs to be taken where issues are out of compliance 814, for example, if a quarterly scan has not been accomplished. If the answer is yes, security personnel may create an issue for remediation 816 in the remediation manager module 210. Even if there are no issues requiring action 814, security personnel may determine that the status of certain issues requires a review of compliance policy to see if a change of policy is necessary 818. If the answer is yes, then the process of establishing the organization's compliance policy 802 begins again for matters related to that issue. If the answer is no, then no changes are made and the process ends.

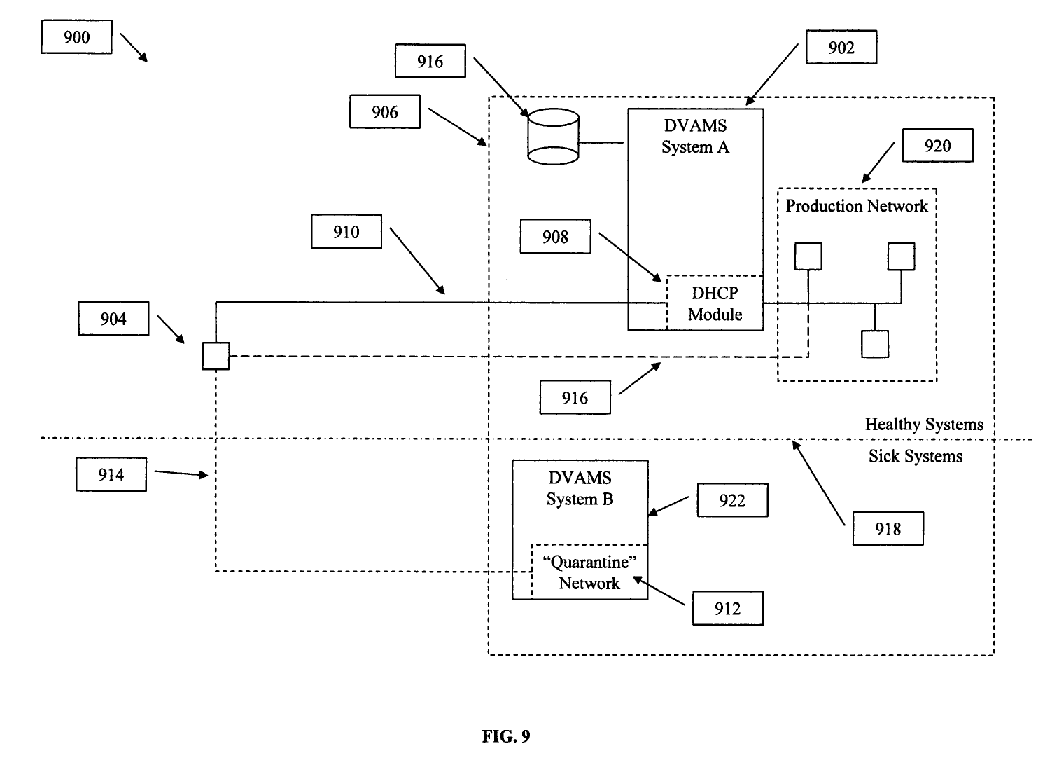

FIG. 9 shows another embodiment of an organizational computer network system 900 including a distributed vulnerability and assessment management system (DVAMS) 902 that can protect a “production network” 920 from infection or attack by an outside or unconnected computer 904. The DVAMS 902 can include a dynamic host configuration protocol (DHCP) module 908 either in software or hardware, likely implemented in the Enterprise Server 102 as another module. However, the DHCP module 908 need not be integrated with the DVAMS 902 but may be a separate system that communicates with the DVAMS 902. One skilled in the art will understand how to implement the communications between the DVAMS 902 and the DHCP module 908 to implement the present invention. An embodiment of a typical DHCP module 908 is described in RFC 2131, March 1997, written by R. Droms.

The DHCP module 908 functions as a gateway between outside systems and the production network 920. The production network 920 is the functioning LAN or network that the organization 906 uses to complete its activities. When a computer 904 desires to gain access or connect to the production network 920, the computer 904 will contact the DHCP module 908 by link 910. If the DHCP 908 grants access to the computer 904, the DHCP module 908 gives the computer 904 an IP address and allows it to connect to the production network 920 via link 916. In the present invention, the DHCP module 908 may also deny access or send the computer 904. For instance, if the computer 904 is found to be a danger to the production network 920, then the DHCP module 908 may provide the computer 904 a null IP address (0.0.0.0) that makes the computer 904 unable to communicate with any network in the organization 906. Thus, the computer 904 cannot establish link 916. In another embodiment, the computer 904 may be found that it should obtain access but presently has a virus or other vulnerability that requires its quarantine. In this embodiment, the DHCP module 908 may provide the computer 904 an IP address, such as 10.0.0.1, that provide access to a quarantine network 912 via link 914. On the quarantine network 912, the computer 904 may find the appropriate tools to ameliorate the vulnerability. Thus, the organization 906 has computer systems separated into healthy systems and sick systems as evidenced by the demarcation line 918. The healthy and sick systems do not communicate between them. Thus, the sick systems cannot infect or affect the healthy systems. If a computer 904 believes it is repaired, the computer 904 can be checked by a second DVAMS 922 located with the sick systems. If the second DVAMS 922 verifies that the vulnerability is indeed repaired, the computer 904 can again ask the DHCP module 908 to allow access. The checks are completed again, and the DHCP module 908 will either give access or send the computer 904 back to the quarantine network 912.

The DVAMS 902 interacts with the DHCP module 908 to determine if the computer 904 posses a security threat. The DVAMS 902 can check an Access Control List (ACL) Database 916 to determine if the computer 904 is on a “bad client list”. In other embodiments, the DVAMS 902 may subject the computer 904 to a security scan to determine if any vulnerabilities or threats are present on the computer 904. These functions are similar to those presented earlier.

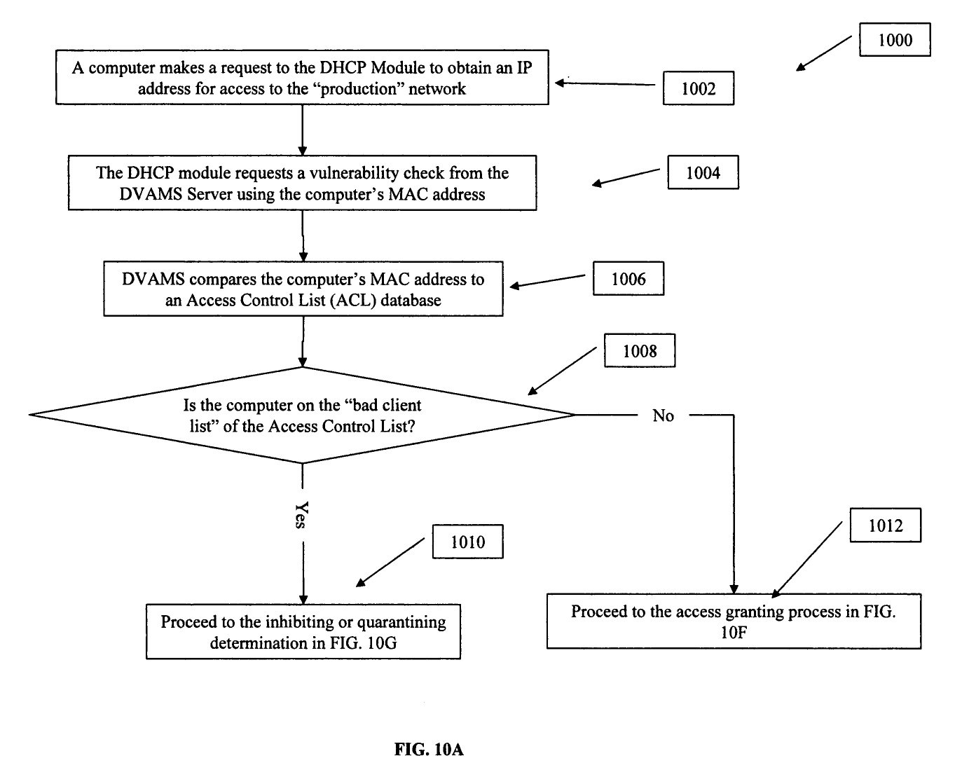

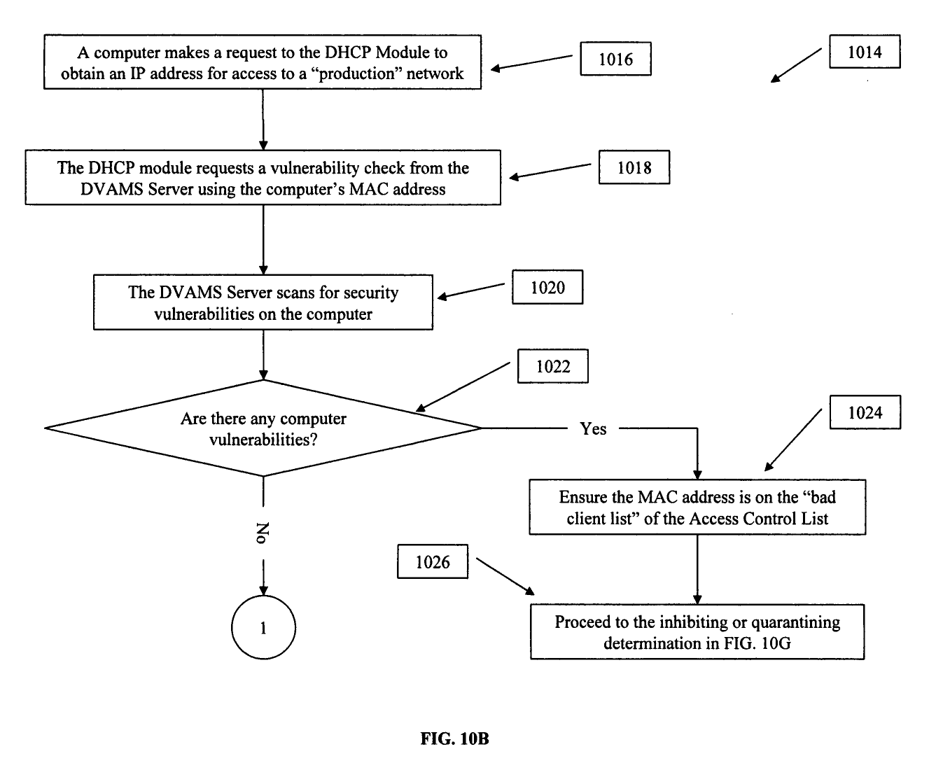

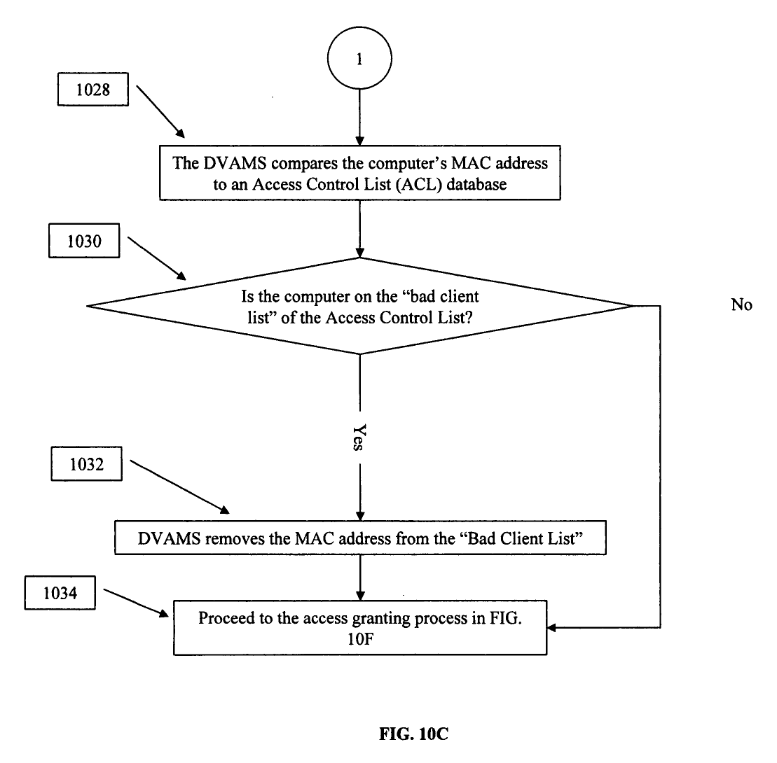

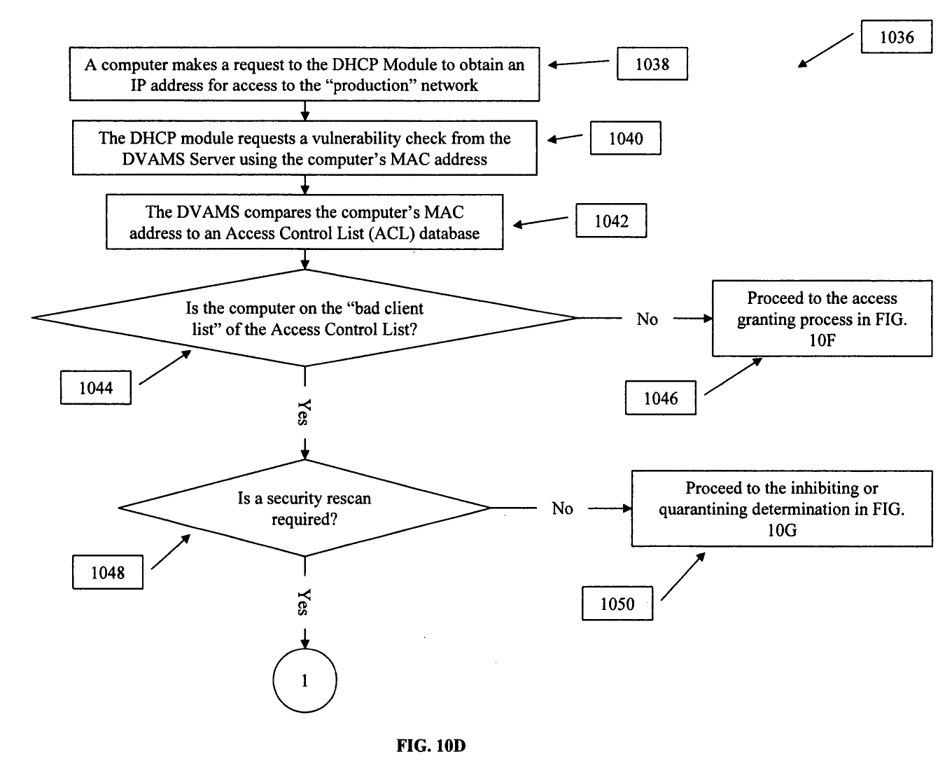

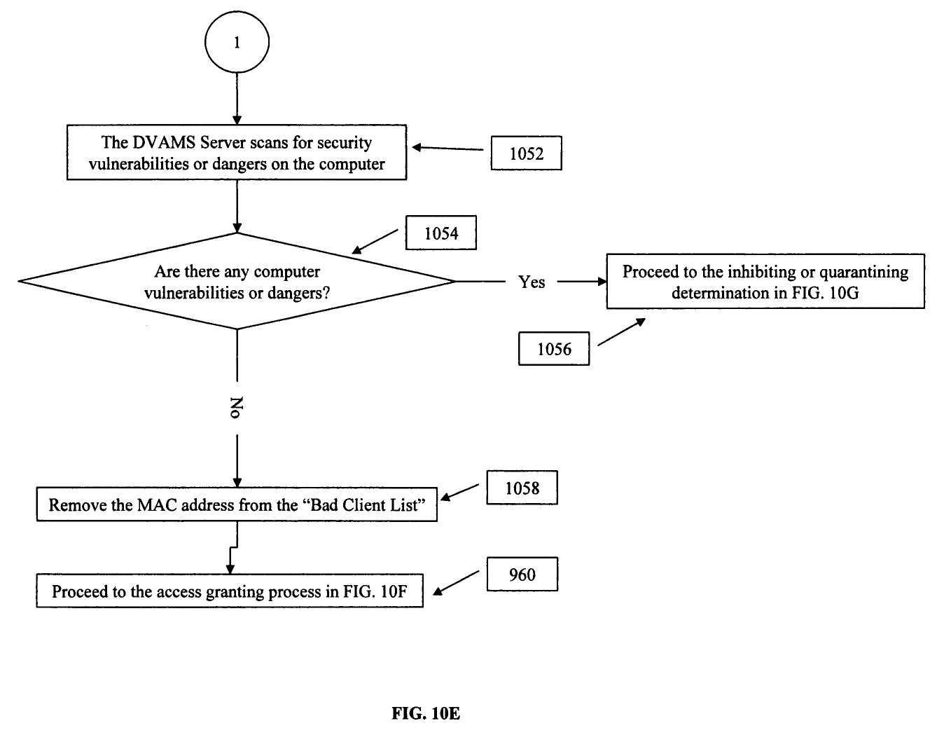

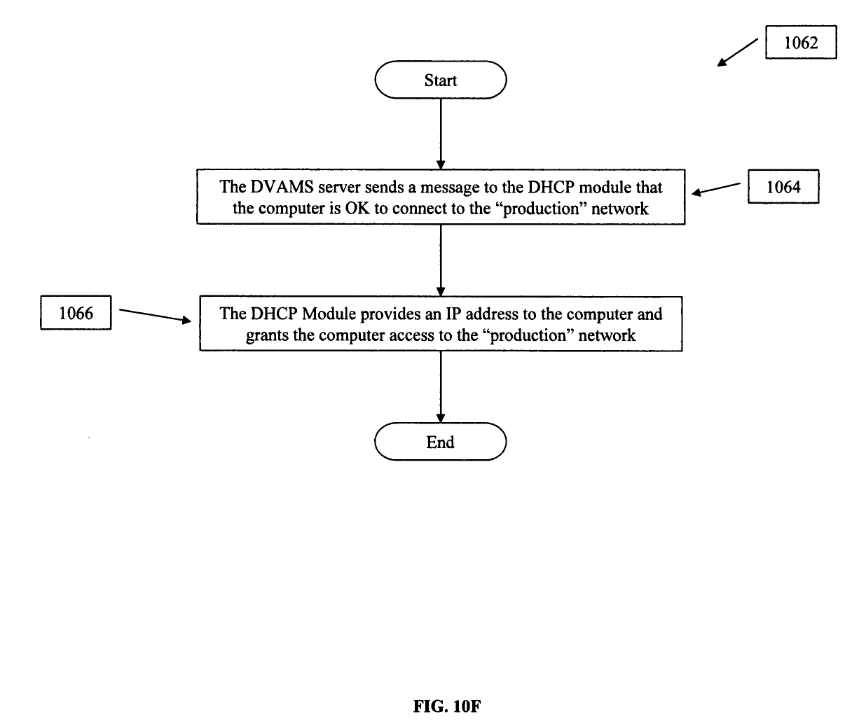

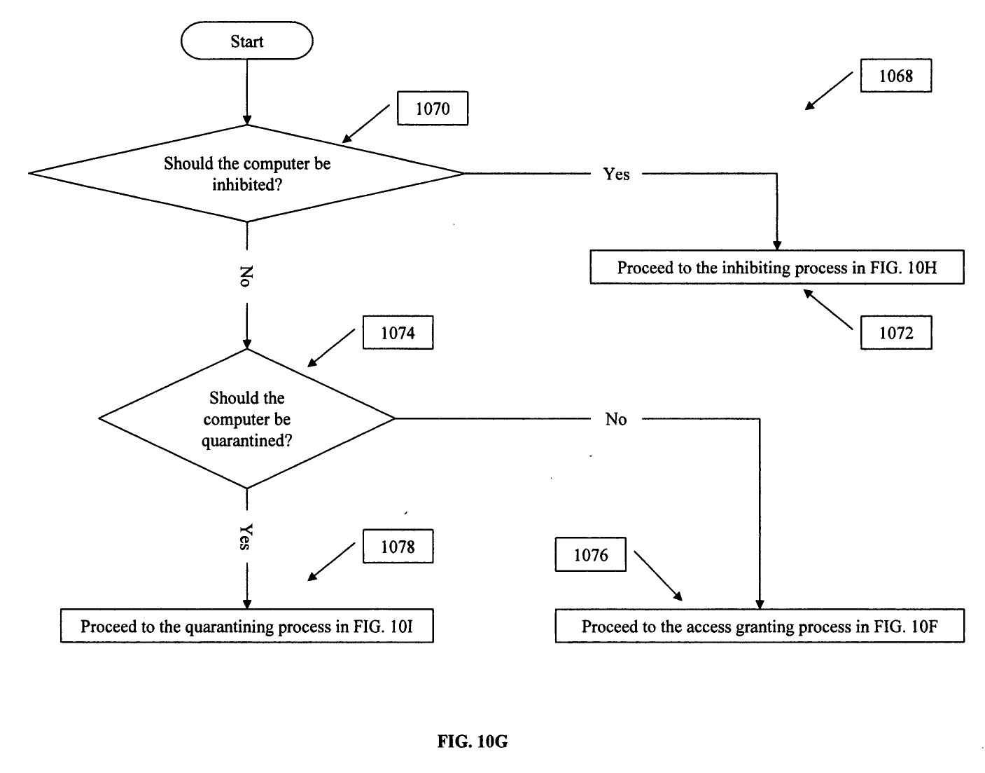

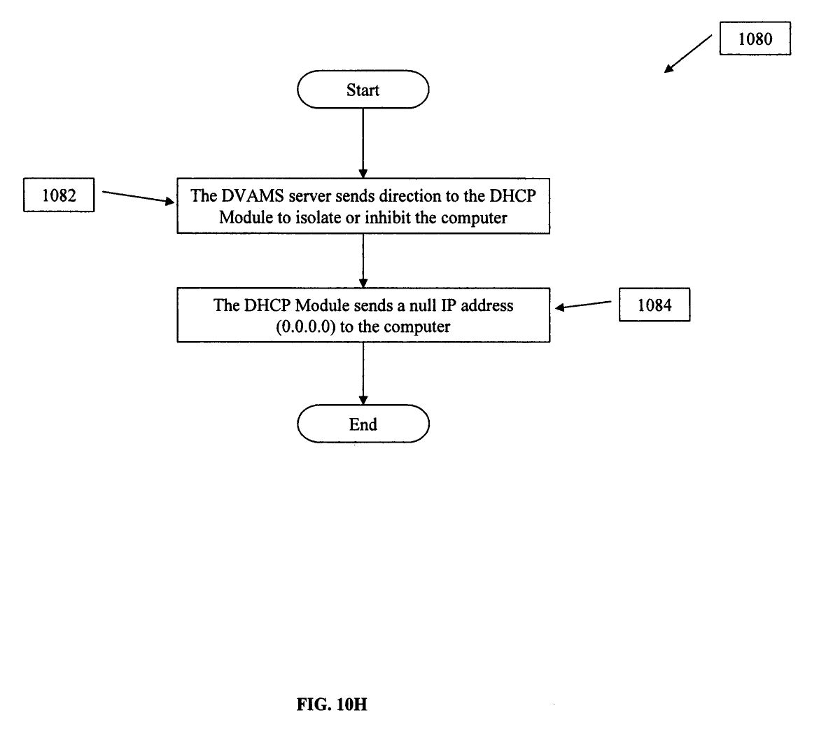

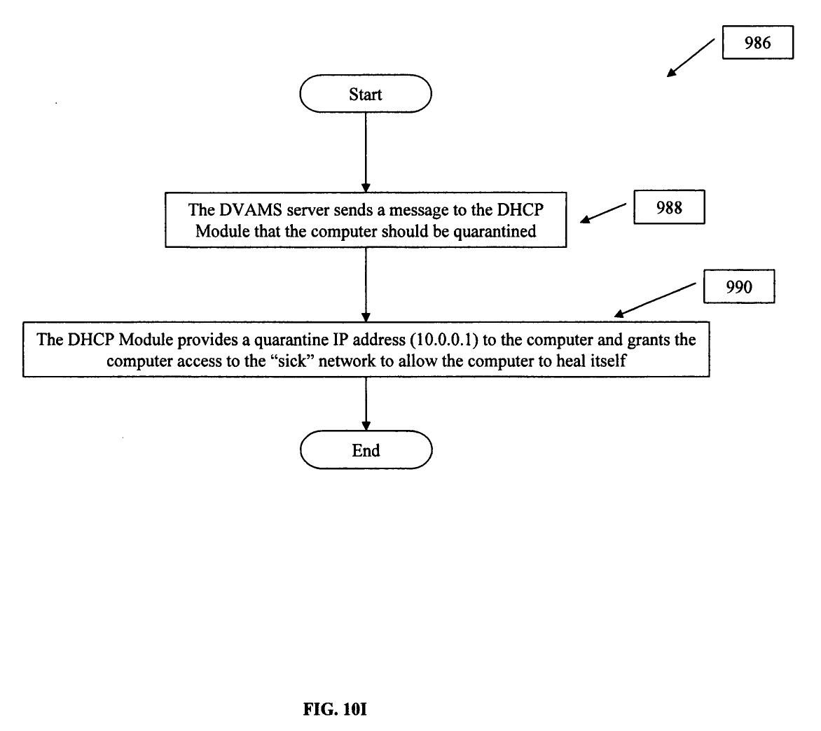

FIG. 10A through FIG. 10I present several embodiments of methods for determining whether a computer 904 should gain access to the organization's networks 906. These embodiments will demonstrate to one skilled in the art how the DHCP and the DVAMS manage to keep the organization's computer systems 906 safe from the introduction of vulnerabilities by an outside computer 904. However, these embodiments may be changed and modified as one skilled in the art will recognize. Thus, the present invention includes the other embodiments that include those changes.

FIG. 10A presents the first embodiment of a method 1000 of determining if a computer 904 should gain access to the organization's systems 906. The computer 904 requests 1002 access to the production network 920. The request, sent to the DHCP module 908, can contain the computer's MAC address. In other embodiments, upon receiving the request, the DHCP module 908 may request the MAC address of the computer 904 and await a response from the computer 904. In either case, the computer 904 supplies the DHCP module 908 with its MAC address. The DHCP module 908 may then request 1004 that the DVAMS Server 902 to do vulnerability checks on the computer 904. In some embodiments, the DHCP module 908 does not make a request of the DVAMS 902, but the DVAMS 902 automatically begins the vulnerability check upon the DHCP 908 receiving the MAC address or request from the computer 904.

The DVAMS 902 checks 906 the MAC address against the Access Control List (ACL) database. The DVAMS searches the ACL to determine if the MAC address is in the bad client list of the ACL. The bad client list of the ACL may be populated automatically through a search of all network components that have vulnerabilities, as explained above, or through a more manual system where an administrator enters the MAC addresses into the ACL. Essentially, the DVAMS 902 determines 1008 if the computer is allowed to connect to the production network and returns either a true or false to the DHCP 908.

If the computer is not on the “bad client list” and is allowed to connect, the process proceeds 1012 to the access granting process 1062 explained below with reference to FIG. 10F. If the computer 904 is on the bad client list, the process proceeds 1010 to the inhibiting or quarantining determination process 1068 explained below with reference to FIG. 10G. This embodiment can be completed with known computers and should be the simplest to implement and quickest to complete.

The next embodiment of a process 1014 to determine if a computer 904 should gain access to the organization's networks 906, shown in FIG. 10B and FIG. 10C, is more suited to unknown or heretofore unseen computers 904. Again in this embodiment, a computer 904 requests 1016 access and the DHCP 908 requests 1018 for a vulnerability check. These steps are similar to the processes explained above and will not be explained further. In this embodiment, the DVAMS 902 communicates with the computer 904. A connection is established and the DVAMS 902 scans 1020 the computer 904 for vulnerabilities. These scans can be similar or the same as those scans completed by the RTDs 104, as explained above. The DVAMS 902 determines 1022 if any vulnerabilities exist.

If a vulnerability exists, the DVAMS 902 ensures 1024 that the computer's MAC address is on the bad client list. In essence, the DVAMS 902 verifies the MAC address is listed or adds the MAC address if it is not listed. Then, the process proceeds 1026 to the inhibiting and quarantining determination process 1068 explained below with reference to FIG. 10G. If no vulnerabilities are discovered during the scan, the DVAMS 902 may still compare 1028 the MAC address to the ACL. The DVAMS 902 determines 1030 if the MAC address is listed on the bad client list. If the MAC address is listed, the DVAMS 902 may remove 1032 the MAC address from the ACL and the process would proceed 1034 to the access granting procedure 1062 explained below with reference to FIG. 10F. If the MAC address is not listed in the bad client list, the process may proceed 1034 directly to the access granting procedure 1062 explained below.

The next embodiment of a method 1036 to determine if access should be granted is shown in FIG. 10D and FIG. 10E. This embodiment may be best suited for computers 904 that have known vulnerabilities and have been placed in the bad client list. As in the above methods, the computer 904 requests access 1038 and the DHCP requests 1040 a vulnerability check. The DVAMS 902 compares 1042 the MAC address to the ACL and checks 1044 the bad client list of the ACL to determine if the MAC address of the computer 904 is on the list. If the MAC address is not listed, the process may proceed 1046 to the access granting process 1062 explained below with reference to FIG. 10F.

However, if the MAC address is listed in the ACL, the DVAMS 902 may determine 1048 if a rescan of the computer 904 is required. If no rescan is required, the process can proceed 1050 to the inhibiting and quarantining determination process 1068 explained below with reference to FIG. 10G. If a rescan is required, the DVAMS 902 may connect with the computer 904 and complete 1052 one or more scans. The DVAMS 902 then determines 1054 if any vulnerabilities exist. If vulnerabilities do exist, the process can proceed 1056 to the inhibiting and quarantining determination process 1068 explained below with reference to FIG. 10G. If no vulnerabilities exist, the MAC address may be removed 1058 from the bad client list, and the process can proceed 1060 to the access granting process 1062 explained below with reference to FIG. 10F.

The access granting process 1062 is shown in FIG. 10F. If the DVAMS determines that the computer should be given access, the DVAMS sends a message or authorizes 1064 the DHCP to grant the computer access. The DHCP provides 1066 a functional IP address to the computer 904. The IP address allows the computer 904 to gain access to the production network 920 by connection with computers on the production network.

The process 1068, for determining whether to inhibit or quarantine the computer 904, is shown in FIG. 10G. The DVAMS 902 determines 1070 if the computer 904 should be inhibited. If the DVAMS 902 does determine that the computer 904 should be inhibited, the process proceeds 1072 to the inhibition process 1080 explained below with reference to FIG. 10H. Typically, computers 904 will be inhibited if they should not be allowed to connect rather than be allowed to repair there vulnerabilities. If the DAVMS 902 determines not to inhibit the computer 904, the DVAMS may then determine 1074 if the computer should be quarantined. If the computer 904 should not be quarantined, the process may proceed 1076 to the access granting process 1062 explained above. However, if the DVAMS 902 does determine that the computer 904 should be quarantined, then the process should proceed 1078 to the quarantining process 1086 explained below with reference to FIG. 101.

An embodiment of the inhibiting process 1080 is shown in FIG. 10H. Inhibiting the computer completely severs communications between the computer and any of the organization's networks. If inhibiting is required, the DVAMS 902 directs 1082 the DHCP 908 to inhibit the computer 904. The DHCP 908 then sends 1084 a null IP address (0.0.0.0) to the computer 904. The null address prevents the computer 904 from connecting to any organization network 906.

An embodiment of a process 1086 to quarantine the computer 904 is shown in FIG. 101. Quarantining a computer 904 involves providing the computer 904 access to an isolated LAN 912 that has tools to fix the vulnerabilities found on the computer 904. Generally, computers 904 that should connect to the organization networks 906 but have some vulnerability are sent to the quarantine network 912. If the computer 904 should be quarantined, then the DVAMS 902 may direct 1088 the DHCP 908 to quarantine the computer 904. The DHCP 908 can send 1090 a quarantine IP address (i.e. 10.0.0.1) to the computer 904 that allows the computer 904 access to only the quarantine network 912. This embodiment allows the computer 904 to heal itself on the quarantine network 912. Once the computer 904 appears healed, the second DVAMS may verify that the vulnerabilities are mitigated or removed. Then, the computer 904 can attempt again to gain access to the production network 920.

We claim:

1. A computer security vulnerability remediation system, comprising:
a. an enterprise server attached to a first network; and
b. one or more remote testing devices attached to one or more remote networks, wherein the enterprise server controls the function of the one or more remote testing devices.

2. A method to scan a distributed network for security vulnerabilities, comprising:
a. establishing an enterprise server on a first network;
b. establishing one or more remote testing devices on one or more remote networks
c. coupling the enterprise server to the one or more remote testing devices;
d. the enterprise server scheduling a scan on at least one or the remote testing devices; and
e. the remote testing device scanning the remote network for security vulnerabilities.

3. A method to create a security policy for a distributed network, comprising:
a. establishing a security policy at an enterprise server on a first network;
b. distributing the security policy from the enterprise server to one or more remote testing devices on one or more remote networks;
c. integrating the security policy into a scanning requirement at the remote testing device;
d. scanning for violations of the security policy; and
e. creating a risk message if any violation of the security policy is found.

4. A method to remediate one or more security vulnerabilities in a distributed network, comprising:
a. receiving scan results, at an enterprise server attached to a first network, from one or more remote testing devices attached to one or more remote networks;
b. consolidating the received results with results generated from a scan of the first network by the enterprise server;
c. resolving one or more of the vulnerabilities; and
d. reporting a resolution to the enterprise server.

5. A method of assimilating and managing the security vulnerabilities and compliance issues across a hierarchical, distributed network, comprising:
a. receiving scan results and compliance posture information from subordinate enterprise server(s) by a master enterprise server;
b. processing the received results and compliance information with results from other subordinate enterprise servers by the master enterprise server to create an organization-wide or individual enterprise server view; and
c. managing the consolidated results, information, and remediation activities across the hierarchical, distributed network.

6. A method of analyzing a network's status against a single or multiple published or proprietary security frameworks or public or private sector regulatory requirements, comprising;
a. receiving scan results and compliance posture information by an enterprise server;
b. a method of storing published security frameworks or regulatory requirements or the ability to create customized, proprietary security frameworks
c. cross-correlation, statistical and differential analysis of the received results and compliance information against one or more security frameworks and regulatory requirements;
d. automatic or manual creation of remediation issues related to the analyzed results; and
e. distribution of remediation issues to relevant parties

7. A method of generating an automated questionnaire that helps evaluate an organization's posture against published or proprietary security frameworks or regulatory requirements, comprising;
a. a method of storing published security frameworks or regulatory requirements or the ability to create customized, proprietary security frameworks;
b. manipulation of the stored security frameworks or regulatory requirements based on user selection such that customized questions are presented to the user that address only areas relevant to the user's actual operating environment; and
c. collection of the user's responses such that the questionnaire can either stand alone or provide the response data to an enterprise server.

8. A method of rules-based, event-driven, automated information security remediation and compliance activity management, comprising;
a. a process to create customized rules related to compliance and security issues for an organization that are correlated with available resources and activities on an enterprise server;
b. the automatic assignment of tasks or launching of an activity based on a related trigger event in the enterprise server's remediation management module;
c. resolving one or more of the security or compliance issues; and
d. reporting a resolution to the enterprise server.
